(19) United States
(12) Patent Application Publication
(10) Pub. No.: US 2020/0320913 A1
(43) Pub. Date: Oct. 8, 2020

(54) Balloon display board

(71) Applicant: Aaron Ray Dewitt, Kansas City, MO (US)

(72) Inventor: Aaron Ray Dewitt, Kansas City, MO (US)

(21) Appl. No.: 16/842,025

(22) Filed: Apr. 7, 2020

Related U.S. Application Data
(60) Provisional application No. 62/919,955, filed on Apr. 8, 2019.

(51) Int. Cl. G09F 19/12; A63H 27/10

(52) U.S. Cl. CPC G09F 19/12; A63H 2027/1041; A63H 27/10

(57) ABSTRACT

A balloon display board with a plurality of spaced apertures for connecting a plurality of balloons in adjacent sequential position to one another in a fascial and inexpensive manner consisting of an elongate flexible strip, made from plastic, cloth or other lightweight flexible material. The apertures, spaced from one another in consistent intervals, employ a plurality of “X-shaped” slits for receiving the neck of a balloon. The apertures may be spaced at any desired distance from one another so as to facilitate insertion of a balloon neck in either a budding relation to an adjacent balloon or at any desired distance therefrom throughout the length and width of the balloon display board.

I claim priority to my provisional patent application No. 62/919,955 filed on Apr. 8, 2019.

### DESCRIPTION

### Field of the Invention

This invention relates to displaying multiple inflated balloons, and more particularly to an apparatus and method for displaying and hanging balloons.

### Background of the Invention

In using balloons for decorative purposes, a plurality of balloons are tied together for display.

U.S. Pat. No. 4,719,651 this expired patent teaches a foldable party hat made of flat panels which have openings to receive the knotted ends of balloons.

U.S. Pat. Nos. 5,675,922 and 5,533,285 teach a grid with openings for displaying balloons. While some of the balloons are positioned using the pneumatic pressure of the balloon itself, others, as shown in FIG. 3 (element 18), are secured to the junction of the frame grid. It is not immediately clear how these balloons are secured other than using the pressure of surrounding balloons.

U.S. Pat. No. 7,507,137 teaches another frame for displaying balloons. While FIG. 17 shows two balloon ends tied together through an opening.

U.S. Pat. No. 6,050,874 this expired patent teaches a strip which can be rolled out and receive the tied ends of balloons in receiver holes along the strip.

U.S. Pat. No. 3,366,999 this expired patent teaches a receiver for receiving the ends of several balloons to join them together.

U.S. Pat. No 2003/0148701 this expired patent application again teaches a device which clips to the ends of balloons. The clips are designed to seal the balloon closed and allow them to be displayed via a string.

UK Pat. No. Gb2424376 this expired patent teaches an assembly for hanging balloons.

Other prior art methods include securing balloons to a board. In each case cited above this would teach away from the present invention which employs X-shaped apertures, which are arguably superior, for receiving the knotted end of a balloon.

### SUMMARY OF THE INVENTION

The present invention aims to remedy all of the shortcomings characterizing the heretofore common and popular practice of hanging or displaying multiple inflated balloons for decorative purposes and other commonly understood uses. The use of strings, sticks, individual plastic clamps, individual plastic tabs, and plastic strips to restrict, tie down or otherwise couple one balloon to another has been ineffective, time consuming and cumbersome. The present invention resolves and precludes all of the disadvantages inherent in the use of commonly known balloon linking devices heretofore. The invention hereof resides in a coupling board made of plastic, paper, cloth or other lightweight flexible material with a plurality of “X-shaped” apertures, spaced at consistent intervals, for the receiving of the neck of the balloon. The invention may be hung for display, laid flat or bent backwards connecting one end of the board to the other end of the board for display and decorative purposes.

The features and advantages of this invention are multi-fold and range from the simplicity of manufacture to its functional installation in practice. The product may be used and or packaged in conjunction with a string or filament for the purpose of aiding in display and decoration of the present invention; however, these components are not necessary for the functionality or manufacture of the present invention. Simplicity of manufacture; superiority of the “X-shaped” aperture, and ease of its use and removal, are its prominent features.

These technical advances represented by the invention, and numerous other features and advantages of the invention hereof will become readily apparent upon reading of the detailed description, claims and drawings which appear hereafter.

### BRIEF DESCRIPTION OF THE DRAWINGS

FIG. 1 is a complete view illustrating the balloon display board.

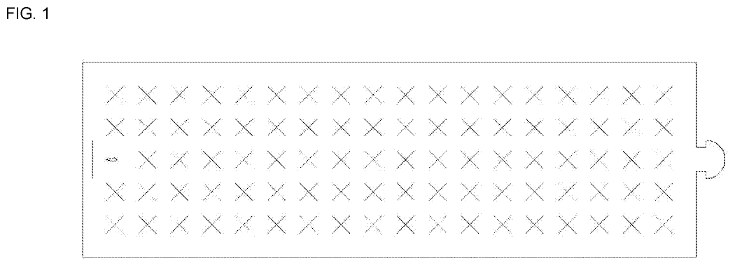

FIG. 2 is a perspective view of the board of FIG. 1 but showing the same rolled into a cylinder for purpose of display.

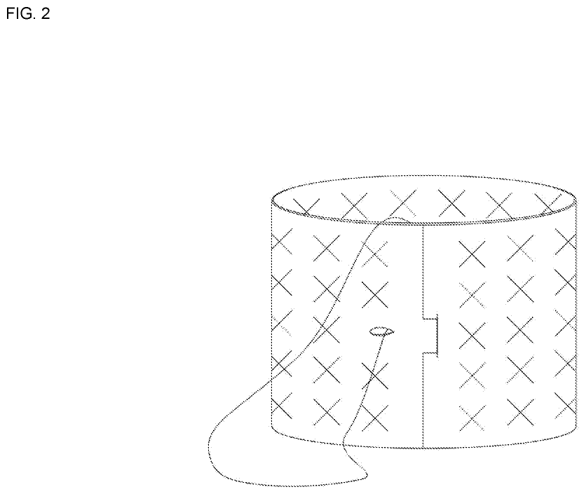

FIG. 3 illustrates actual use of the balloon display board of the invention showing a plurality of balloons secured to the balloon display board in a pre-arranged array in which each is deployed and organized in predetermined distance with respect to the others by reason of the fixed distance apertures of the balloon display board.

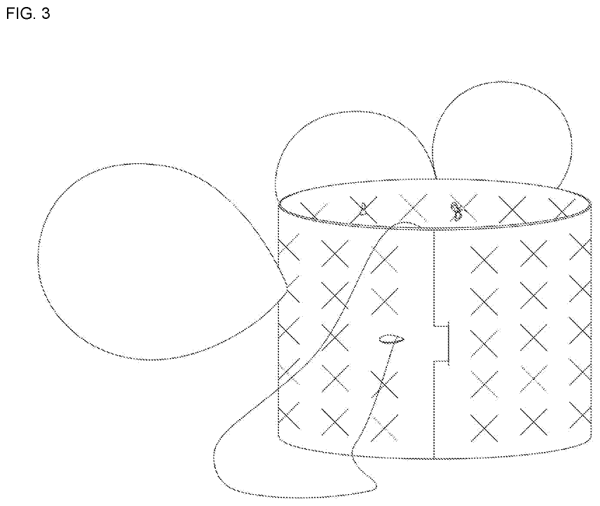

### DETAILED DESCRIPTION OF THE INVENTION

The present invention is directed to an extendible lightweight coupling board which may be made from a fabric, polystyrene or other flexible material. The dimensional characteristics of the coupling board are such that it may easily be carried and used by one person, and the length may range from approximately twenty-five inches, or less, and the width may range from approximately 14 inches, or less. These dimensions are approximations but are generally found to be sufficient. Both width and length may, however, be influenced by the chosen material.

The coupling board is characterized by a plurality of apertures which are “X”-shaped and are generally placed in a grid-like pattern at regular, consistent intervals. The apertures are spaced from one another at a distance of approximately one inch from the center of the preceding “X” shape or edge of the board, thereby providing the user with a wide range of selection in deciding the configuration of the balloon array. The diameter of the apertures are consistent throughout the present invention. As here described, the apertures consist of two tangent lines that intersect at a right angle, which thus describes the “X”-shape. However, the number of intersecting lines may be influenced by the chosen material. In either case, the shape is superior to accept and secure the neck of the balloon to the coupling board and to restrict the escape of the balloon from the aperture due to the rolled nature of balloon lips, particularly after the neck is knotted. The design of the aperture is such as to minimize the receiving space needed to secure practically any and all balloon sizes to the coupling board so that the attachment is firm and minimizes the frequency of unintended balloon detachment.

Therefore that which is claimed and desired to be secured by a United States Letters Patent is:

1. An improved arrangement of novelty balloons form a decorative display, the arrangement comprising:
(a) A balloon, each balloon having a neck;
(b) A board having a plurality of apertures therethrough, wherein said board is flexible, lightweight, and sufficiently small to be transported by an individual, each of the balloons being disposed with the neck thereof in one of the apertures, the neck of each balloon being secured within the aperture.

2. The means of securing claim 1 wherein the aperture comprises a plurality of slits that intersect at their respective midpoint.
